(19) United States
(12) Patent Application Publication
(10) Pub. No.: US 2022/0170758 A1
(43) Pub. Date: Jun. 2, 2022

(54) SMART SCHEDULING AND MITIGATING DISRUPTIONS BASED ON ENVIRONMENT CONDITIONS

(71) Applicant: METROPOLITAN LIFE INSURANCE CO., New York, NY (US)

(72) Inventor: Terrance Luciani, Monroe Township, NJ (US)

(21) Appl. No.: 17/109,413

(22) Filed: Dec. 2, 2020

(51) Int. Cl. G01C 21/34; G01C 21/36; G06Q 10/06

(52) U.S. Cl. CPC G01C 21/3492; G01C 21/3484; G06Q 10/06312; G01C 21/3691; G01C 21/3415

(57) ABSTRACT

A smart scheduling system determines a baseline set of user preferences based on at least one prior arrival time relative to a prior event time. The system also receives new event data including a new event time and a new event location, and further, determines a predicted travel time from an origin location to the new event location based on one or more historic environment conditions and the baseline set of user preferences. Based on the predicted travel time, the system generates a notification having an initial notification time. The system also monitors real-time environment conditions corresponding to at least one travel route from the origin location to the new event location, and determines a revised notification time based on the real-time environment conditions. The system provides the notification to one or more client devices associated with a user based on the revised notification time.

### TECHNICAL FIELD

The present disclosure relates generally to scheduling systems, and more particularly to smart scheduling systems that mitigate scheduling disruptions.

### BACKGROUND

Electronic devices such as mobile phones, tablets, smart watches, and so on have become a mainstay in daily life. The prevalent, convenient, and readily accessible nature of electronic devices creates opportunities to leverage technology for managing schedules, organizing calendars, or otherwise coordinating event attendance. For example, consumers often have multiple devices with programs that sync electronic calendars. These programs typically provide notifications or alerts on each device regarding scheduled events at a manually programmed pre-event times to ensure on-time arrival. While these programs can coordinate and sync electronic calendars across multiple devices, the pre-event time, whether manually programmed or set by default, often fails to account for environment conditions such as traffic, weather, accidents, and so on, that can cause travel delays and late arrival times. At the same time, the prevalent nature of modern electronic devices in all aspects of life presents opportunities for new technologies that monitor, quantify, and account for environmental conditions and mitigate schedule disruptions.

### BRIEF DESCRIPTION OF THE DRAWINGS

The embodiments herein may be better understood by referring to the following description in conjunction with the accompanying drawings in which like reference numerals indicate identical or functionally similar elements. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a schematic diagram of an example smart scheduling environment, showing a smart scheduling system that communicates with various client devices over a network;

FIG. 2 illustrates a schematic diagram of an example smart scheduling device;

FIG. 3 illustrates a schematic block diagram of the smart scheduling system shown in FIG. 1, further showing an individual profile module, an environment monitoring module, and a smart scheduler module;

FIG. 4 illustrates a schematic block diagram of the smart scheduling system shown in FIG. 3, further showing example operations for environment monitoring and providing notifications;

FIG. 5 illustrates a schematic block diagram of the smart scheduling system shown in FIG. 3, further showing example operations for automatically updating an alarm notification; and

FIG. 6 illustrates a schematic block diagram of the smart scheduling system shown in FIG. 3, further showing example operations for mitigating schedule disruptions; and

FIG. 7 illustrates an example simplified procedure for smart scheduling and mitigating disruptions.

### DESCRIPTION OF EXAMPLE EMBODIMENTS

### Overview

According to one or more embodiments of this disclosure, a smart scheduling system automatically mitigates scheduling disruptions. In one example, the smart scheduling system determines a baseline set of user preferences based on at least one prior arrival time relative to a prior event time. The smart scheduling system also receives new event data including a new event time and a new event location, and further, determines a predicted travel time from an origin location to the new event location based on one or more historic environment conditions and the baseline set of user preferences. Based on the predicted travel time, the smart scheduling system generates a notification having an initial notification time. The smart scheduling system also monitors real-time environment conditions corresponding to at least one travel route from the origin location to the new event location, and generates a revised notification time based on the real-time environment conditions. The smart scheduling system provides the notification to one or more client devices associated with a user based on the revised notification time. These and other features will be discussed herein with respect to various exemplary embodiments of the disclosed stress monitoring and intervention system.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

A smart scheduling environment includes a communication network, which is a geographically distributed collection of devices interconnected by communication links and segments for transporting data there-between. The devices include, for example, electronic devices such as personal computers, laptops, tablets, mobile phones, and the like. Many types of networks are available, ranging from local area networks (LANs) to wide area networks (WANs). LANs typically connect these nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, etc.

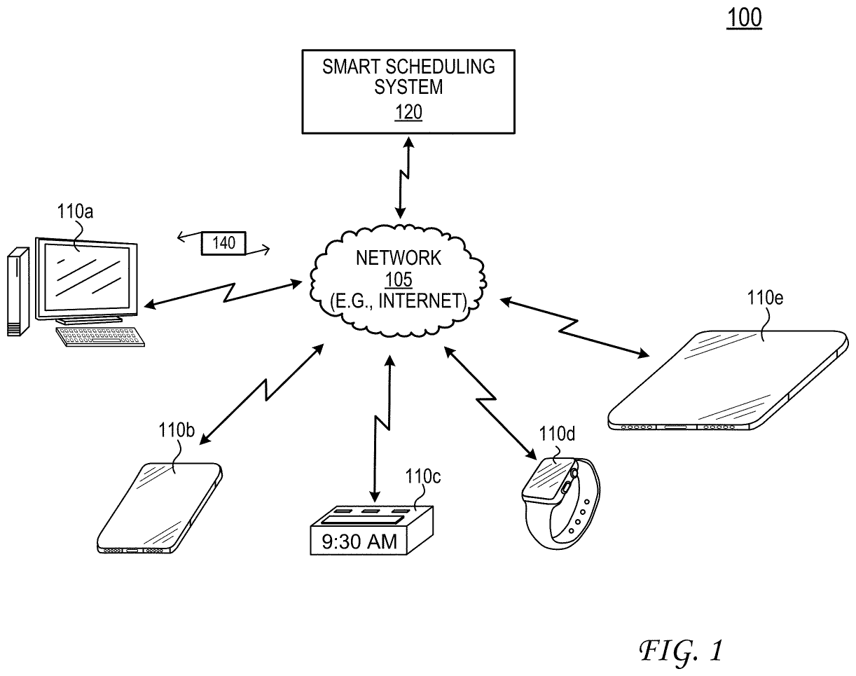

Referring to the figures, FIG. 1 illustrates a schematic diagram of a smart scheduling environment 100, which includes an example communication network 105 (e.g., the Internet). Communication network 105 is shown for purposes of illustration and can represent various types of networks, including local area networks (LANs), wide area networks (WANs), telecommunication networks (e.g., 4G, 5G, etc.), and so on.

As shown, communication network 105 includes a geographically distributed collection of client devices, such as devices 110a, 110b, 110c, 110d, and 110e (collectively, “devices 110”). Devices 110 are interconnected by communication links and/or network segments and exchange or transport data such as data packets 140 to/from a smart scheduling system 120. Here, devices 110 include a computer 110a, a mobile device 110b, a smart alarm 110c, a wearable device 110d, and a tablet 110e. The illustrated client devices represent specific types of electronic devices, but it is appreciated that devices 110 in the broader sense are not limited to such specific devices. For example, devices 110 can include any number of electronic devices such as laptops, smart watches, wearable smart devices, smart glasses, smart home devices, other wearables, and so on. In addition, those skilled in the art will understand that any number of devices and links may be used in communication network 105, and that the views shown by FIG. 1 is for simplicity and discussion.

Data packets 140 represent network traffic or messages, which are exchanged between devices 110 and smart scheduling system 120 over communication network 105 using predefined network communication protocols such as wired protocols, wireless protocols (e.g., IEEE Std. 802.x, WiFi, Bluetooth®, etc.), Power Line Carrier (PLC) protocols, or other shared-media protocols where appropriate. In this context, a protocol comprises a set of rules defining how devices interact with each other.

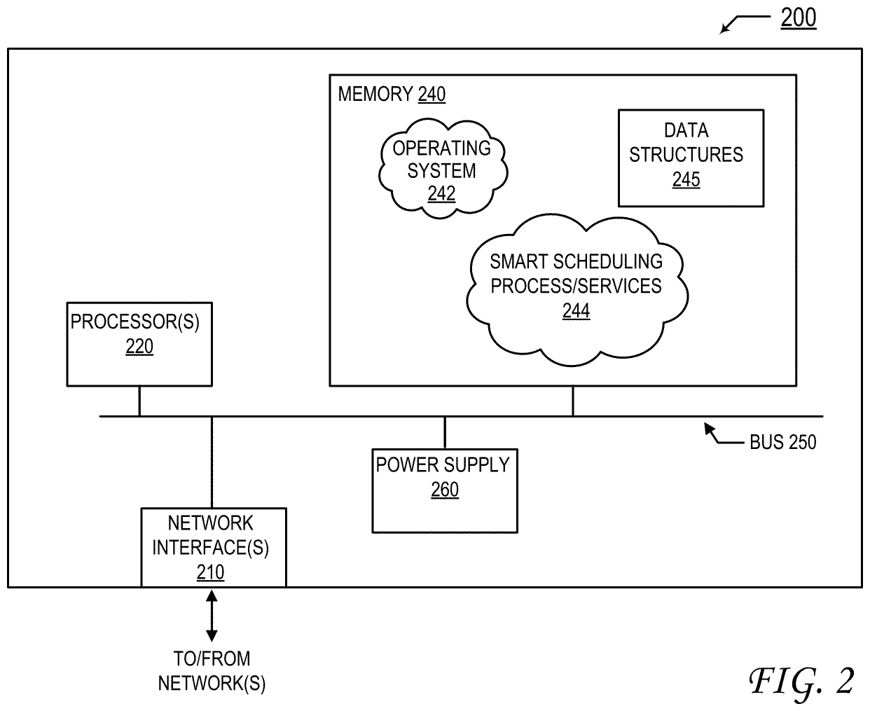

FIG. 2 is a schematic block diagram of an example device 200 that may be used with one or more embodiments described herein, e.g., as a component of smart scheduling system 120 and/or as any one of devices 110 shown in FIG. 1.

Device 200 comprises one or more network interfaces 210 (e.g., wired, wireless, PLC, etc.), at least one processor 220, and a memory 240 interconnected by a system bus 250, as well as a power supply 260 (e.g., battery, plug-in, etc.).

Network interface(s) 210 contain the mechanical, electrical, and signaling circuitry for communicating data over the communication links coupled to communication network 105. Network interfaces 210 are configured to transmit and/or receive data using a variety of different communication protocols. As illustrated, the box representing network interfaces 210 is shown for simplicity, and it is appreciated that such interfaces may represent different types of network connections such as wireless and wired (physical) connections. Network interfaces 210 are shown separately from power supply 260, however it is appreciated that the interfaces that support PLC protocols may communicate through power supply 260 and/or may be an integral component coupled to power supply 260.

Memory 240 comprises a plurality of storage locations that are addressable by processor 220 and network interfaces 210 for storing software programs and data structures associated with the embodiments described herein. In some embodiments, device 200 may have limited memory or no memory (e.g., no memory for storage other than for programs/processes operating on the device and associated caches).

Processor 220 comprises hardware elements or logic adapted to execute the software programs (e.g., instructions) and manipulate data structures 245. An operating system 242, portions of which are typically resident in memory 240 and executed by the processor, functionally organizes device 200 by, inter alia, invoking operations in support of software processes and/or services executing on the device. These software processes and/or services may comprise smart scheduling process/services 244, described herein. Note that while smart scheduling process/services 244 is illustrated in centralized memory 240, alternative embodiments provide for the process to be operated within the network interfaces 210, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the smart scheduling process 244 is shown as a standalone process, those skilled in the art will appreciate that this process may be executed as a routine or module within other processes.

As noted above, the prevalent nature of modern electronic devices in all aspects of life presents opportunities to create, integrate, and design new technologies for monitoring, quantifying, and accounting for environment conditions and mitigating schedule disruptions. For example, a consumer traveling for business may be staying in a hotel in an unfamiliar place. The consumer sets a pre-event alarm time for an upcoming scheduled event. However, the consumer is unaware of, or is unfamiliar with local environment conditions (e.g., rush hour traffic) that could impact travel time from the hotel to the event. In addition, the consumer is asleep when a sudden storm or accident occurs that also causes additional unexpected travel delay.

The consumer may ultimately run late or miss the scheduled event because the pre-event alert time failed to account for historic (e.g., rush hour traffic) or real-time (e.g., sudden storm) environment conditions. Local individuals such as hosts, front desk employees, and so on, may be able to provide tribal knowledge to help the user determine and set appropriate pre-event alert times, however such local individuals are not always available and may not have accurate information. Moreover, some real-time environment conditions simply cannot be accounted for in advance. Accordingly, while conventional scheduling programs coordinate and sync electronic calendars across multiple devices, certain challenges remain in predicting and mitigating scheduling disruptions.

The techniques described herein provide a comprehensive smart scheduling platform that monitors user preferences, environment conditions (e.g., historic and real-time), quantifies the impact of potential travel delay on the travel time, revises notification or alert times, and provides notifications to ensure “on-time” arrival for a scheduled event or otherwise mitigate travel disruptions. While some of the disclosed techniques focus, in part, on providing notifications to a specific user, the notifications disclosed herein may be coordinated and distributed in the broader sense to multiple users scheduled to attend the same event. In this fashion, the disclosed smart scheduling platform can notify other users of potential event delays and reassign tasks to mitigate schedule disruptions. The smart scheduling platform can include various systems (e.g., smart scheduling system 120), devices (e.g., device 200), and processes (e.g., procedure 700).

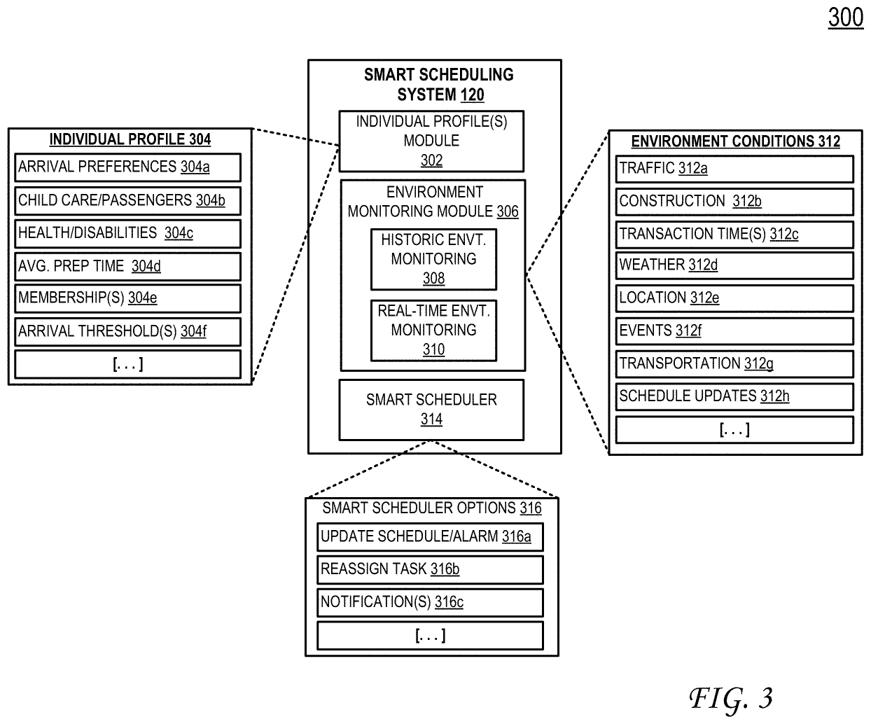

Referring again to the figures, FIG. 3 illustrates a schematic block diagram 300, showing component modules of smart scheduling system 120. Collectively, the component modules cooperate to quantify predicted travel time, and mitigate scheduling disruptions for a scheduled event. The travel time generally corresponds to the time it takes for the user to traverse a travel route between an origin location and an event location, and as used herein, the term travel time encompasses user preparation time prior to embarking on the travel route.

As shown, the component modules of smart scheduling system 120 include an individual profile module 302, an environment monitoring module 306, and a smart scheduler module 314.

Individual profile module 302 includes a database of profiles or preferences for individual users such as an individual profile 304. Individual profile 304 represents a baseline set of user preferences that correspond to user-specific travel time, and the user-specific travel time represents a time impact (e.g., potential delay) that a given user's preferences have on a recommended departure time to arrive “on-time” for a scheduled event. The user preferences associated with individual profile 304 include arrival preferences 304a, child care or passengers 304b, health or disability conditions 304c, an average preparation time 304d, membership(s) 304e, arrival thresholds 304f, and so on.

Arrival preferences 304a represent a preferred arrival time relative to a scheduled event, such as a preference to arrive early (or even late) relative to the start time of the scheduled event. Child care or passengers 304b represents a potential delay time caused by additional travel companions. For example, the user may require additional time to get ready to leave and/or require an additional stop when the user travels with a toddler or another passenger (e.g., stopping by a daycare or a school). Health or disability conditions 304c represent additional time associated with a given user's health or disability. For example, a user that needs a wheelchair may require additional transition time to/from various modes of transportation and require wheelchair access to the scheduled event building or facility. Average preparation time 304d represents an average amount of time that the particular user takes to get ready to leave for the scheduled event. Membership(s) 304e represent metrics that account for status (or non-status) that can impact wait times (e.g., TSA memberships, HOV-access memberships, etc.). For example, a user with a TSA pre-check membership avoid long lines at an airport and thus, require less time than a user who does not have any TSA pre-check membership. In this fashion, the user's membership can reduce the travel time for an on-time arrival, while the user's lack of a membership can delay or add to the travel time. Arrival thresholds 304f represent preferences or even requirements to arrive within a specified window of time relative to the scheduled event. For example, if the user is more than 10 minutes late to a dinner reservation, the reservation may be canceled. Alternatively, if the user arrives too early to a scheduled event, the user may have to wait for the doors to open. In this fashion, arrival thresholds 304f may be adjusted depending on the requirements for the scheduled event.

In some embodiments, the individual preferences 304 can also reflect user-specific travel time associated with the user's preferred vehicle type (e.g. small sedan, large SUV, AWD, front WD, etc.) and/or modes of transportation (e.g. walk/run/bike; mass transit, private; ride-share; and parking).

In operation, individual profile module 302 updates the user preferences for each individual profile 304 to accurately account for user-specific travel time. Individual profile module 302 updates a given user's preferences by receiving or determining a revised user preference and updating the baseline set of user preferences to create a revised set of user preferences. Users can manually input updated user preferences, or individual profile module 302 can extract data from client devices for the user and determine revised preferences based on extracted data.

In some embodiments, individual profile module 302 monitors user behavior to learn and/or update that user preferences stored in individual profile 304. Individual profile module 302 can access devices associated with the user and data sources associated with such devices, including personal calendars, scheduling tools, global positioning system (GPS) data, emails, text messages, and so on. Individual profile module 302 thus monitors the user's behavior and updates the user's preferences accordingly.

In one example, individual profile module 302 monitors GPS data, social media check-ins, and the like to determine the user prefers to stop by a coffee shop on the way to work. Individual profile module 302 adjusts metrics corresponding to that user's average preparation time 304d (or other non-illustrated preferences) to account for the extra time associated with the stop, and in turn, smart scheduling system 120 adjusts a notification time to depart earlier for a future event to factor in a coffee stop on the way.

Individual profile module 302 also evaluates various user preferences to determine a relevant user-specific travel time for a travel route to a scheduled event. In this context, relevance refers to an association or relationship between the user's preferences and the type of scheduled event. As one example, the user's arrival preferences 304a can include granular metrics mapped or related to specific types of events. Arrival preferences 304a can include granular arrival metrics mapped to catching a flight, attending a business meeting, attending a casual gathering, and so on. In this fashion, the user may prefer to arrive an hour early to catch a flight, 15 minutes early to attend a business meeting, and 30 minutes late to attend a casual gathering.

In another example, the scheduled event is a flight. Here, individual profile module 302 determines that the user prefers to arrive at the airport an hour early (e.g., arrival preferences 304a) and further, the user's average preparation time corresponding to the flight event is 45 minutes (e.g., average preparation time 304d). Individual profile module 302 aggregates the user-specific time for each user preference relating to the flight event to yield a total predicted user-specific travel time of 1 hour and 45 minutes. Environment monitoring module 306 and/or smart scheduler module 314 further adjust the travel route, notification time, and/or take other actions based on the user-specific travel time to ensure on-time arrival for the flight.

In another example, smart scheduling system 120 determines the relevant user-specific travel time corresponding to average preparation time 304d based on an iterative analysis of user behavior. In this example, smart scheduling system 120 monitors the user's electronic calendar on devices 110 over network 105, determines when the user inputs new event data into the electronic calendar, and extracts or receives new event time and the new event location information corresponding to the new event data.

More specifically, the user's mobile phone (or other devices) executes a smart scheduling application that transmits messages corresponding to the user picking up the device (e.g., accelerometer data), an alarm acknowledgement, sending a text message, or other interaction data to smart scheduling system 120. Individual profile module 302 further monitors or determines timestamp data associated with the user's devices to determine the time when the user wakes up and/or begins preparing to travel.

Individual profile module 302 also determines the time when the user departs his or her current location to travel to the scheduled event. Again, individual profile module 302 monitors interaction data from the user's device(s) to determine the departure time (e.g., based on accelerometer data, GPS data, ride share applications, taxi applications, etc.). Individual profile module 302 monitors user behavior by iteratively measuring and averaging the time intervals corresponding to preparation time for scheduled events to determine metrics associated with the user's average preparation time.

Environment monitoring module 306 determines and quantifies an environment travel time (e.g., in seconds, minutes, hours, etc.) for the travel route to the event based on one or more environment conditions 312. In this context, the environment travel time represents a potential or predicted time impact or delay that various environment conditions will have on a travel route from an origin location to the event location.

Environment monitoring module 306 includes a historic environment monitoring module 308 and a real-time environment monitoring module 310. As shown, both modules are configured to monitor the same and/or similar set of environment conditions 312, however historic environment monitoring module 308 monitors past or prior conditions, and real-time environment monitoring module 310 monitors current conditions.

Environment conditions 312 include, for example, traffic conditions 312a, construction zones 312b, transaction times 312c (such as an expected wait time at toll booths or coffee shop), and weather conditions 312d that could affect travel times and conditions (e.g. flooding, decreased visibility, extreme heat). Environment conditions 312 can also include locations 312e of scheduled events relative to a location of a user, planned or unplanned events 312f that might obstruct traffic such as sports games or protest marches, and transportation updates 312g (e.g. light rail stations may be closed due to a police situation or the bus might be late due to mechanical problems).

In some embodiments, transportation updates 312g represents vehicle conditions, including fuel level, engine status (e.g., “check engine”), tire pressure, maintenance, and other conditions that may affect departure time, travel time, or arrival time. Environment conditions 312 also include schedule update 312h, which represents updates that impact the travel time and/or travel route to the planned event. For example, schedule updates 312h can include event delays, cancelations, postponements, and so on. Environment monitoring module 306 can monitor and receive schedule updates 312h by accessing data sources such as a calendar, emails or text messages associated with user's devices—e.g. the user receives an email from a coworker to postpone a meeting; or the user receives a text notification that a flight is cancel.

It is also appreciated that the illustrated environment conditions 312 are provided for purposes of discussion, not limitation and further, each monitoring module can monitor different and/or additional environment factors.

In operation, environment monitoring module 306 determines a travel route from an origin location (e.g., a user's current location) to the scheduled event (e.g., a destination location). Environment monitoring module 306 determines and selects the travel route from a plurality of potential travel routes based on a number of factors such as total distance, total time, number of lights, avoid highways, and so on. Alternatively, environment monitoring module 306 receives the travel route from other modules (not shown). Environment monitoring module 306 also monitors environment conditions 312 corresponding to the travel route.

In some embodiments, environment monitoring module 306 employs web crawlers, automated scripts, and/or application programming interfaces to extract and aggregate data corresponding to environment conditions 312 for the travel route(s) from various data sources, including for example, GPS data, client device data (e.g., from devices 110), traffic monitoring data, weather data, local news sources, construction/city planning data, user-reported traffic obstructions (e.g. indicating items such as road debris or speed traps), transaction times or wait times, planned event data, transportation data, public announcements, and local event data. Environment monitoring module 306 evaluates the various environment conditions for the travel route and determines a total environment travel time based on the same.

In some embodiments, environment monitoring module 306 applies weights to historic and/or real-time data to accurately predict the environment travel time for the given travel route. For example, environment monitoring module 306 applies a greater weight to real-time data over historic data when real-time data is likely to have a greater impact on the travel time for the travel route (and vice versa). In another example, environment monitoring module 306 applies a greater weight for similar historic data corresponding to the same time, same day of the week, and etc., over dissimilar historic data corresponding to different times, different days, and etc. It is also appreciated that environment monitoring module 306 can employ machine learning components to learn how environment conditions 312 (historic and/or real-time) affect travel time to predict the total environment travel time for travel route(s).

Smart scheduler module 314 communicates with individual profile module 302 and environment monitoring module 306, aggregates travel time data from individual profile module 302 (e.g., the user-specific travel time) and/or environment monitoring module 306 (e.g., environment travel time), and determines appropriate corrective actions (e.g., smart scheduler options 316) based on the same.

Smart scheduler options 316 include, but are not limited to, an update schedule/alarm option 316a to suggest or otherwise set an updated alarm or schedule time for an event, a task reassignment option 316b, and an option to view and/or send one or more notifications 316c in response to a predicted or suggested schedule change.

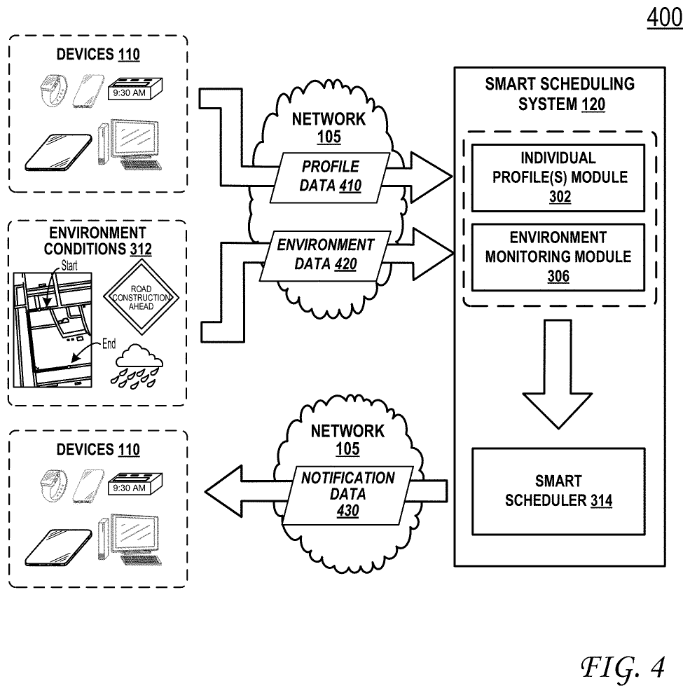

Collectively, the component modules of smart scheduling system 120 quantify potential travel time and mitigate scheduling disruptions for a scheduled event based on the same. These operations are further shown and described with reference with FIG. 4.

FIG. 4 illustrates a schematic block diagram 400, showing operations and data flow for smart scheduling system 120. At a high level, individual profile module 304 monitors and receives profile data 410 from devices 110, and environment monitoring module 306 monitors and receives environment data 420 from various data sources. Profile data 410 represents data corresponding to individual user preferences stored in individual profiles (e.g., corresponding to individual profiles 304). Environment data 420 represents data corresponding to historic and/or real-time environment data (e.g., environment conditions 312).

As discussed above, individual profile module 304 and environment monitoring module 306 quantify travel time, including user-specific travel time and environment travel time. As shown, individual profile module 304 and environment monitoring module 306 monitor profile data 410 and environment data 420 to respectively determine user-specific travel time and environment travel time. Smart scheduler module 314 further aggregates the user-specific travel time and/or environment travel time to determine a total travel time for a travel route to a scheduled event, and executes corrective or mitigating actions (e.g., smart scheduler options 316) based on the total travel time. As shown, the corrective or mitigating actions include sending or transmitting notification data 430 over network 105 to one or more devices 110. Notification data 430 includes updates, revisions, notifications, alerts, and so on, which operably revise schedules, revise notification times, update alarms, reassign tasks, send new notifications to other users, push notifications, and etc. As one example, notification data 430 can include a revised schedule time that updates a wake-up or departure alarm on the devices associated with the user.

End-to-End Example #1. In this example, smart scheduling system 120 receives and/or extracts new event data from devices 110 associated with a user over network 105. The new event data includes a new event time and a new event location. Individual profile module 302 monitors profile data 410 to determine a baseline set of user preferences based on reported or observed user data (e.g., prior arrival time(s) relative to scheduled event time(s)). Individual profile module 302 further determines an individual or user-specific travel time associated with the new event based on the baseline set of use preferences.

Environment monitoring module 306 determines (or selects) a travel route from an origin location to the event location. Environment monitoring module 306 monitors environment data 420 corresponding to the travel route, and predicts a total environment travel time based on an initial travel time for the travel route and potential delays for the travel route based on historic and/or real-time environment conditions 312.

Smart scheduler module 314 aggregates the user-specific travel time from individual profile module 302 and the environment travel time from environment monitoring module 306 to determine a total predicted travel time time. Smart scheduler module 314 further determines appropriate corrective actions (e.g., smart scheduler options 316) to avoid or mitigate potential schedule disruptions and ensure “on-time” arrival at the scheduled event.

End-to-End Example #2. In another example, the scheduled event is a post-work event at a location near the user's office building. Individual profile module determines the user prefers to arrive at post-work events 15 minutes early, which corresponds to a user-specific travel time of 15 minutes. Environment monitoring module 306 determines or selects the travel route for the user to ensure on-time arrival for the scheduled event.

Environment monitoring module 306 further monitors a weather report that predicts rains along the travel route. Environment monitoring module 306 evaluates historic data for the travel route to determine the environment travel time is 15 minutes—e.g., the same weather for similar days for the travel route causes a 15 minute delay. Environment monitoring module 306 also monitors current road-construction occurring along the travel route. Environment monitoring module 306 further determines the road-construction will cause an additional 15 minute environment delay. Environment monitoring module 306 aggregates the historic and real-time environment travel times to predict a 30 minute total environment travel time.

Smart scheduler module 314 aggregates the 30 minute total environment travel time and 15 minute user-specific travel time to determine a total 45 minute travel time. Smart scheduler module 314 further executes corrective actions to mitigate and/or avoid a scheduling disruption and ensure on-time arrival based on the 45 minute travel time. Here, smart scheduler module 314 instructs environment monitoring module 306 to select or identify an alternative travel route and/or smart scheduler module 314 updates a notification or alert time to depart 45 minutes earlier.

In some examples, smart scheduler module 314 updates notifications on the user's devices (e.g., devices 110) by sending notification data 430 to the same. In these examples, the client device(s) has/have a notification set for an initial notification time. The initial notification time can indicate a time to wake up, depart, or otherwise prepare for the event. Smart scheduler module 314 determines the total travel time requires an adjustment to the initial notification time to ensure on-time arrival at the event. As discussed, individual profile module 302 and/or environment monitoring module 306 provide respective user-specific travel time and environment travel time to the smart scheduler module 314, which aggregates these times to determine the total travel time. Smart scheduler module 314 further determines that the initial notification time may result in a late arrival time for the scheduled event and/or an arrival time outside a user-preferred arrival threshold (e.g., arrival thresholds 304f). Smart scheduler module 314 further generates a revised (e.g., earlier) notification time to mitigate or avoid the late arrival time, and sends the revised notification time (e.g., notification data 430) to the appropriate user devices (e.g., devices 110) over network 105. In turn, the user devices update corresponding notifications for the scheduled event based on the revised notification time.

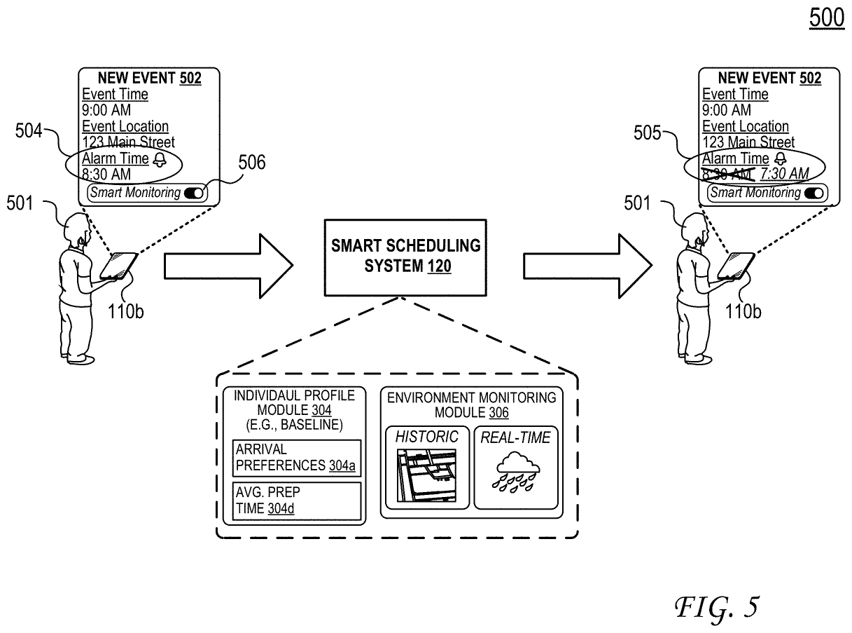

FIG. 5 illustrates a schematic block diagram 500, showing another end-to-end example of smart scheduling system 120 operations to automatically update an alarm notification time for mobile device 110b.

Initially, user 501 inputs a new event data corresponding to new event 502 into an electronic calendar associated with mobile device 110b. The new event data includes an event time, an event location, and an initial notification time 504 for “8:30 AM.” In this example, user 501 enables a smart scheduling application and corresponding smart scheduling operations by toggling smart monitoring option 506. The smart scheduling application is represented by smart scheduling system 120.

Smart scheduling system 120 sets the initial notification time 504 for 30 minutes prior to the scheduled event time or “9:00 AM” based on an initial predicted travel time. Individual profile module 302 determines a 20 minute user-specific travel time based on arrival preference 304a and average preparation time 304d, and environment monitoring module 306 determines a 10 minute environment travel time for the travel route to the scheduled event. Smart scheduling system 120 aggregates the user-specific travel time and the environment travel time to determine the initial 30 minute predicted travel time.

Smart scheduling system 120 continues to monitor environment conditions and identifies reports of thunderstorms that will impact the travel time for the travel route to new event 502. Environment monitoring module 306 determines the thunderstorms will have a 1 hour time impact or delay to the environment travel time based on historic and/or real-time data. Smart scheduling system 120 generates a revised notification time 505 that will ensure on-time arrival and transmits the same to mobile device 110b. In turn, mobile device 110b updates new event 502 to reflect the revised notification time (7:30 AM). In this fashion, smart scheduling system 120 avoids or mitigates schedule disruptions.

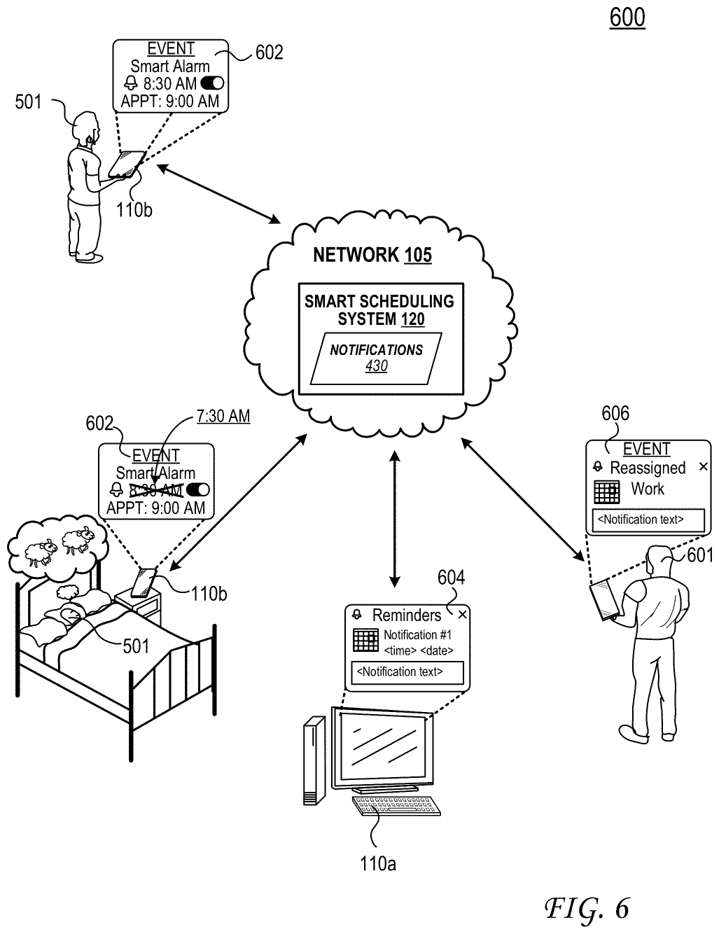

FIG. 6 illustrates a schematic block diagram 600, showing additional operations to mitigate a schedule disruption. In FIG. 6, user 501 enters new event data for a new event 602 into mobile device 110b. New event 602 represents a work meeting for the following day, where the user is staying a hotel in an unfamiliar city.

As shown, smart scheduling system 120 communicates with mobile device 110b over network 105 and extracts or receives the new event data for new event 602. Smart scheduling system 120 determines the user-specific travel time and/or environment travel time and sets a smart alarm to wake up the user 30 minutes prior to the scheduled event or at 8:30 AM to ensure on-time arrival for 9:00 AM. In some embodiments, the user can initially input and/or set an initial notification time.

While user 501 is sleeping, smart scheduling system 120 monitors historic and/or real-time environment conditions and updates the predicted travel delay. When the predicted travel delay exceeds a threshold and will result in a schedule disruption, smart scheduling system 120 executes one or more corrective actions.

As shown, the corrective actions include generating and transmitting notifications 430 to various devices. Notifications 430 operably update the smart alarm time to be 1 hour earlier (7:30 AM), update or revise calendar reminders 604 for attendees to the scheduled event to indicate a potential late arrival by user 501, and new notifications 606 that reassign the work to another user 601, who will arrive to the scheduled event on-time. In this fashion, smart scheduling system 120 mitigates or avoids scheduling disruptions.

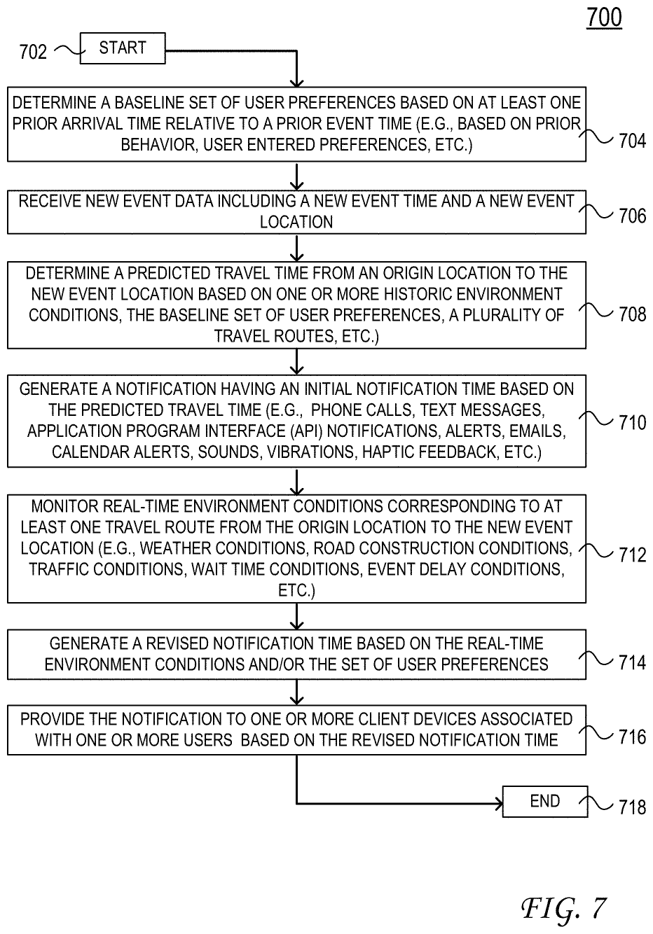

FIG. 7 illustrates an example simplified procedure 700 for smart scheduling in accordance with the examples and processes described above. For purposes of discussion, the operations for procedure 700 are described in the context of a system such as smart scheduling system 120. However, it is appreciated that these operations may be performed by any number of systems and devices, including combinations of systems and devices in a distributed computing environment.

Procedure 700 begins at step 702, and continues to step 704, where, as described above, the system determines a baseline set of user preferences based on at least one prior arrival time relative to a prior event time. For example, the system can determine user preferences based on prior behavior such as average preparation times for a user relative to prior arrival times for corresponding events. In some examples, the user may directly input his or her user entered preferences, and even revise stored preferences.

As discussed, the user preferences generally represent user-specific context to help the system account for and quantify the time that a specific user requires (or prefers) for an “on-time” arrival relative to a scheduled event. For example, the user preferences can account for travel companions and/or child care needs, e.g., if the user is traveling with a child (or a passenger), that user may require additional time for stops, loading/unloading equipment (e.g., strollers, bags, toys, etc.), and so on. The user preferences can also account for user-specific health and disabilities. For example, some users may require additional time and thus, leave earlier for a scheduled event due to health conditions and/or disabilities. In addition, the user preferences also include arrival time thresholds, which establish a user's preference for that user's preferred “on-time” arrival relative to a scheduled event. For example, some users may prefer to arrive early to an event, while other users may prefer to arrive on-time or even late to an event.

Procedure 700 continues to step 706, where the system receives new event data, which includes a new event time and a new event location. The system further determines, in step 708, a predicted travel time from an origin location to the new event location based on one or more historic environment conditions, the baseline set of user preferences (e.g., user-specific travel delay), a plurality of travel routes, etc. For example, the system analyzes a plurality of travel routes and environment conditions for such travel routes (e.g., environment travel delay) to determine the predicted travel time.

At step 710, the system further generates a notification at an initial notification time based on the predicted travel time. As discussed, the notification can include various types of alerts, phone calls, text messages, application program interface (API) notifications, emails, calendar alerts, sounds, vibrations, haptic feedback, and so on.

At step 712, the system continues to monitor real-time environment conditions corresponding to at least one travel route from the origin location to the new event location. These real-time environment conditions represent dynamic or changing conditions that impact the predicted travel time for the travel route(s). These real-time conditions include, for example, weather conditions, road construction conditions, traffic conditions, wait time conditions, event delay conditions, and so on. Notably, exemplary wait time conditions include an average amount of time a person waits in line at the scheduled event location (e.g., DMV lines, airport lines, bus lines, store lines, etc.), and exemplary event delay conditions include delays, cancellations, and postponements.

The system further generates a revised notification time at step 714 based on the real-time environment conditions and/or the set of user preferences. Here, the system determines and quantities the time impact of the real-time environment conditions (e.g., environment travel time) and the user's preferred “on-time” arrival (e.g., user-specific travel time), and generates a revised notification time based on the same. Notably, the revised notification time can replace the initial notification time, or in some embodiments, the revised notification time can supplement the initial notification time. For example, when the system provides the notification to one or more client devices at step 716, the system can provide the notification at both the revised notification time in addition to providing the notification at the initial notification time. As discussed, the notification can also include messages that indicate task reassignment, a meeting time changes, delays, a meeting cancelations, and so on.

In some embodiments, the system provides the notification to one or more client devices associated with a particular user. In other embodiments, the system provides the notification to other client devices associated with different users. For example, the system can provide a delay notification to multiple users that are scheduled to attend the same event. The system can also provide task reassignment, meeting cancelations, meeting time changes, and so on, to any number of users scheduled to attend the event.

Procedure 700 subsequently ends at step 718, but may continue on to step 704 where, as discussed above, the system determines the baseline set of user preference that impact arrival times for scheduled events.

It should be noted that certain steps within procedure 700 may be optional, and further, the steps shown in FIG. 7 are merely examples for illustration—certain other steps may be included or excluded as desired. Further, while a particular order of the steps is shown, this ordering is merely illustrative and any suitable arrangement of the steps may be utilized without departing from the scope of the embodiments herein.

The techniques described herein, therefore, describe a dynamic and flexible scheduling model that anticipates and mitigates scheduling disruptions by taking into account individual preferences and habits of a user as well as historical and real-time environmental factors outside of the control of the user. The present system allows a user to set a notification time for a scheduled event and will alter the notification time or provide other mitigation options as needed to ensure that the user achieves their desired scheduling outcome. The present system leverages various software solutions to help a user manage their time by providing dynamic schedule notifications and by anticipating any disruptions.

While there have been shown and described illustrative embodiments of a stress monitoring and intervention system, it is to be understood that various other adaptations and modifications may be made within the spirit and scope of the embodiments herein. For example, the embodiments have been shown and described herein with relation to a specific system that organizes certain functions into modules or engines. However, the embodiments in their broader sense are not as limited, and may, in fact, be used with any number of applications, devices, and systems as part of a distributed computing network.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium, devices, and memories (e.g., disks/CDs/RAM/EEPROM/etc.) having program instructions executing on a computer, hardware, firmware, or a combination thereof. Further, methods describing the various functions and techniques described herein can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on. In addition, devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example. Instructions, media for conveying such instructions, computing resources for executing them, and other structures for supporting such computing resources are means for providing the functions described in these disclosures. Accordingly this description is to be taken only by way of example and not to otherwise limit the scope of the embodiments herein. Therefore, it is the object of the appended claims to cover all such variations and modifications as come within the true spirit and scope of the embodiments herein.

1. A smart scheduling system, comprising:
one or more network interfaces configured to communicate with one or more client devices over communication network;
a processor coupled to the network interfaces and adapted to execute one or more processes; and
a memory configured to store instructions executable by the processor, the instructions, when executed, are configured to:
determine a baseline set of user preferences based on at least one prior arrival time relative to a prior event time;
receive new event data including a new event time and a new event location;
determine a predicted travel time from an origin location to the new event location based on one or more historic environment conditions and the baseline set of user preferences;
generate a notification based on the predicted travel time, the notification having an initial notification time;
monitor real-time environment conditions corresponding to at least one travel route from the origin location to the new event location;
generate a revised notification time based on the real-time environment conditions; and
provide the notification to the one or more client devices based on the revised notification time.

2. The smart scheduling system of claim 1, wherein the instructions are further configured to:
receive at least one revised user preference; and
update the baseline set of user preferences based on the at least one revised user preference to create a revised set of user preferences, and
wherein the instructions to generate the revised notification time are further configured to determine the revised notification time based on the revised set of user preferences.

3. The smart scheduling system of claim 1, wherein the instructions to generate the revised notification time are further configured to generate the revised notification time based on the baseline set of user preferences.

4. The smart scheduling system of claim 1, wherein the instructions to determine the baseline set of user preferences are further configured to:
determine an average preparation time for a user based a plurality of prior preparation times associated with a plurality of prior arrival times for respective prior events.

5. The smart scheduling system of claim 1, wherein the instructions to provide the notification to one or more client devices are further configured to:
provide the notification to a first client device associated with a first user; and
provide the notification to a second client device associated with a second user, different from the first user.

6. The smart scheduling system of claim 1, wherein the notification includes a message that indicates at least one of a task reassignment, a meeting time change, or a meeting cancelation.

7. The smart scheduling system of claim 1, wherein the instructions to monitor the real-time environment conditions are further configured to:
monitor at least one of a weather condition, a road construction condition, a wait time condition, or an event delay condition.

8. A method for smart scheduling comprising:
determining a baseline set of user preferences based on at least one prior arrival time relative to a prior event time;
receiving new event data including a new event time and a new event location;
determining a predicted travel time from an origin location to the new event location based on one or more historic environment conditions and the baseline set of user preferences;
generating a notification based on the predicted travel time, the notification having an initial notification time;
monitoring real-time environment conditions corresponding to at least one travel route from the origin location to the new event location;
generating a revised notification time based on the real-time environment conditions; and
providing the notification to one or more client devices associated with a user based on the revised notification time.

9. The method of claim 8, wherein generating the revised notification time further comprises generating the revised notification time based on the baseline set of user preferences.

10. The method of claim 8, further comprising:
receiving at least one revised user preference; and
updating the baseline set of user preferences based on the at least one revised user preference to create a revised set of user preferences, and
wherein generating the revised notification time further comprises determining the revised notification time based on the revised set of user preferences.

11. The method of claim 8, wherein determining the baseline set of user preferences further comprises:
determining an average preparation time for a user based a plurality of prior preparation times associated with a plurality of prior arrival times for respective prior events.

12. The method of claim 8, wherein providing the notification to one or more client devices, further comprises:
providing the notification to a first client device associated with a first user; and
providing the notification to a second client device associated with a second user, different from the first user.

13. The method of claim 8, wherein determining the predicted travel time from the origin to the new event location further comprises determining the predicted travel time based on a plurality of travel routes from the origin location to the new event location.

14. The method of claim 8, wherein providing the notification to the one or more client devices, further comprises:
providing at least one of a phone call, a text message, an application program interface (API) notification, an email, a calendar alert, a sound, or a vibration.

15. The method of claim 8, wherein the notification includes a message that indicates at least one of a task reassignment, a meeting time change, or a meeting cancelation.

16. The method of claim 8, wherein monitoring the real-time environment conditions further comprises monitoring at least one of a weather condition, a road construction condition, a wait time condition, or an event delay condition.

17. The method of claim 8, wherein the baseline set of user preferences corresponds to at least one of a preferred arrival time prior to a scheduled event, an average preparation time, a health condition, a disability condition, or an indication of one or more travel companions.

18. A tangible, non-transitory, computer-readable media having instructions encoded thereon, the instructions, when executed by a processor, are operable to:
determine a baseline set of user preferences based on at least one prior arrival time relative to a prior event time;
receive new event data including a new event time and a new event location;
determine a predicted travel time from an origin location to the new event location based on one or more historic environment conditions and the baseline set of user preferences;
generate a notification based on the predicted travel time, the notification having an initial notification time;
monitor real-time environment conditions corresponding to at least one travel route from the origin location to the new event location;
generate a revised notification time based on the real-time environment conditions; and
provide the notification to one or more client devices based on the revised notification time.

19. The tangible, non-transitory, computer-readable media of claim 18, wherein the instructions, when executed by the processor, are further configured to:
receive at least one revised user preference; and
update the baseline set of user preferences based on the at least one revised user preference to create a revised set of user preferences, and
wherein the instructions to generate the revised notification time are further configured to determine the revised notification time based on the revised set of user preferences.

20. The tangible, non-transitory, computer-readable media of claim 18, wherein the instructions to generate the revised notification time are further configured to generate the revised notification time based on the baseline set of user preferences.
